(19) United States
(12) Patent Application Publication
(10) Pub. No.: US 2006/0293065 A1
(43) Pub. Date: Dec. 28, 2006

(54) Dynamic information on demand

(75) Inventors: Gary Chew, Naperville, IL (US); Anil P. Macwan, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/167,353

(22) Filed: Jun. 27, 2005

(51) Int. Cl. H04M 1/66; H04M 1/68; H04Q 7/20; H04M 3/16

(52) U.S. Cl. 455/456.3; 455/456.1

(57) ABSTRACT

Systems and methods are presented for providing dynamic temporally and geographically relevant information or content to mobile communications devices, in which a profile and a current location are obtained for a mobile device, profile specific geographically and temporally relevant content from a data store according to the user profile, the current user location, and the current time, and the content is provided to mobile communications device via a communications network.

### FIELD OF THE INVENTION

The present invention relates to telecommunications generally, and more particularly to systems and methods for providing dynamic information to telecommunications users based on current location and time.

### BACKGROUND OF THE INVENTION

Wireless telecommunications systems provide subscribers or users the opportunity to travel from place to place while maintaining the ability to communicate via mobile devices or units, such as cell phones, pagers, personal digital assistants (PDAs), laptop computers, etc. As a result of this portability, mobile communications has proliferated in recent years and various types of wireless mobile communications networks have been developed, including cellular networks (e.g., ANSI41 type networks, GSM networks, etc.) that operate according to signaling protocols such as signaling system 7 or common channel signaling 7 (e.g., SS7 or CCS7), as well as IMS/WiFi networks (Internet Protocol Multimedia Subsystem/Wireless Fidelity) or other internet protocol (IP) based networks. Cellular networks are typically constructed to provide communications service to non-subscribing visiting mobile units that move or roam into an area not supported by the subscribed (home) network. When a mobile device moves into a new cell supported by a given base station and an associated mobile switching center (MSC), the device registers with the visited MSC and is thereafter served by this MSC, with subscriber profile information being transferred to the serving MSC from a home MSC.

Although conventional cellular phone service allows a subscriber to travel to many locations while maintain the ability to place and receive phone calls, it may be desirable to receive other useful information pertaining to the visited location at a given time. Although PDAs and other mobile devices currently allow a user to search the Internet from any given location, the searched information may not be relevant to the current user location or to the current season, data, day, time of day, etc. Accordingly, there is a need for improved wireless communications systems and methods for providing dynamic information or content to mobile communications devices based on current location, current time, and profile information for a given wireless subscriber.

### SUMMARY OF THE INVENTION

A summary of one or more aspects of the invention is now presented to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The invention relates to systems and methods for dynamically providing profile specific geographically and temporally relevant information or content to mobile communications devices based on current location, current time, and profile information for a given subscriber. The invention may be implemented using existing networks, such as conventional ANSI41 or GPS cellular wireless networks, IMS/WiFi or other IP-based networks, conventional wireline networks, and intelligent networks which may interconnect many different wireless networks in forming a mobile communications system, in which static and dynamic information is stored in one or more network elements.

User profile information is stored, which may include personal subscriber information (e.g., name, address, indications of services to which the user subscribes, etc.) along with one or more content databases with content entries having advertisements or other information and geographical and temporal relevance parameters. Logic is provided in the system to get the profile/preferences for a given mobile device user, as well as the current device location, and to obtain profile specific geographically and temporally relevant information or content from the content database(s) based on the current location, current time, and profile information, which is then pushed to the user device through a wireless call session. The invention thus provides databases and logic to allow a user to receive pertinent content according to the user's profile or preferences in a timely fashion, while filtering information that does not relate to the current location or the present time. The user benefits by receiving only the useful information without having to perform manual searches, and the content providers also benefit by directing advertisements or other commercial content to users who want or can benefit from the information. The dynamic content services can be provided to specific devices as a subscribed service, and the content provider can even pay for the cost of the calls to encourage use by the customer. In this fashion, advertisers can target their audience more effectively, in a situation that approaches direct one-to-one marketing of goods or services that are relevant to the user at the time the call is placed and at the user's current location.

One aspect of the invention relates to a method for providing dynamic information to mobile communications devices based on current location, current time, and profile information. The method provides for obtaining a device's current location, as well as obtaining a corresponding profile from a profile database in the mobile communications system, where the profile can include personal information and preferences, along with information about specific types of dynamic content services to which the user subscribes. The method further includes providing profile specific geographically and temporally relevant content to the mobile communications device via a communications network according to the user profile, the current user location, and the current time. The content may be provided by searching a content database maintained in the system according to the user profile, the current user location, and the current time. In other implementations, a number of geographically relevant databases are provided, such as for different MSCs in a cellular system, where the inventive method provides for searching the geographically relevant database corresponding (e.g., including content relevant to) the current user location, where the selected database is searched according to the user profile and the current time. Another approach involves providing only currently relevant information entries in the geographically relevant content databases, whereby the search is only restricted by the user's profile or preferences. In another case, the user may provide search parameters to dynamically adjust the profile content searched, for example, to allow a non-sports far to receive information on a sporting event when entertaining clients, etc.

Another aspect of the invention provides a dynamic content system for providing geographically and temporally relevant content to mobile communications devices. The system includes first and second data stores, with the first data store having profile entries corresponding to individual mobile communications devices in a mobile communications system, and the second data store including content entries that individually comprise content, at least one geography relevance parameter, and at least one time relevance parameter. The system further includes a logic component that obtains a profile entry for a given mobile communications device from the first data store and obtains profile specific geographically and temporally relevant content from the second data store according to the user profile, the current user location, and the current time. The logic also operates to provide this content to the given mobile communications device via a communications network.

Yet another aspect of the invention provides a system for providing dynamic information to mobile communications devices. The system includes a profile database in the mobile communications system, means for obtaining a profile for a mobile communications device from the profile database, and means for obtaining a current location for the mobile communications device in the mobile communications system. The system further comprises means for selectively providing profile specific geographically and temporally relevant content to the mobile communications device via a communications network according to the user profile, the current user location, and the current time.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1 is a simplified system view illustrating a mobile communications system with a system for providing geographically and temporally relevant content to mobile communications devices in accordance with one or more aspects of the invention;

FIG. 2 is a flow diagram illustrating a method for providing dynamic information to mobile communications devices based on current location, current time, and profile information according to the invention;

FIG. 3 is a system diagram illustrating various implementations of the systems of the invention in the communications system of FIG. 1;

FIG. 4 is a schematic diagram illustrating an exemplary profile database with profile entries for a number of wireless communications devices, each entry having profile information and subscription information;

FIGS. 5A and 5B illustrate an exemplary profile entry in the profile database of FIG. 4, showing user preferences and details of subscription information related to the dynamic content services of the present invention;

FIG. 6 is a schematic diagram illustrating an exemplary content database stored in the mobile communications system of FIGS. 1 and 3, including entries with content, geography relevance parameters and time relevance parameters;

FIG. 7 is a schematic diagram illustrating a geographically relevant content database with entries having content and time relevance parameters;

FIG. 8 is a partial system diagram illustrating an exemplary implementation of the invention with geographically relevant content databases being provided with individual MSCs according to the invention; and

FIG. 9 is a schematic diagram illustrating a geographically and temporally relevant content database in the mobile communications system, in which individual content entries are relevant to the current time.

### DETAILED DESCRIPTION OF THE INVENTION

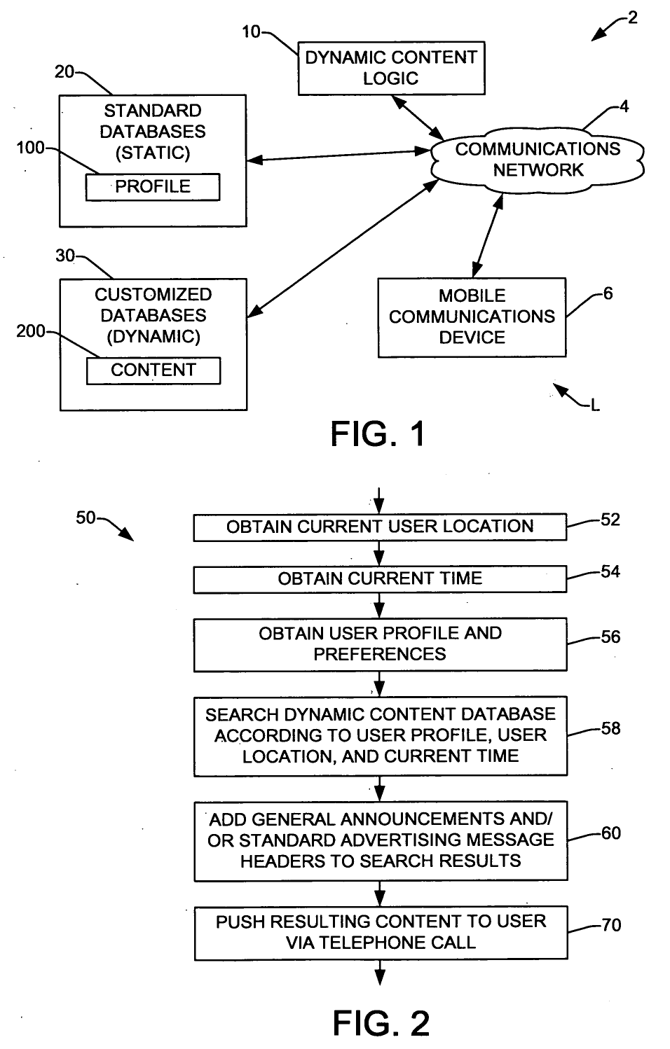

Referring initially to FIG. 1, one or more exemplary embodiments or implementations of the present invention are hereinafter illustrated and described, wherein like reference numerals are used to refer to like elements throughout and wherein the invention is not limited to the illustrated examples. While illustrated and described below in the context of particular wireless telecommunications networks and systems, the invention finds utility in association with any type of communications apparatus and systems, including but not limited to cellular and IP-based mobile communications networks. The various aspects of the invention relate to systems and methods for pushing geographically and temporally relevant information or content to users of mobile communications devices, in which the current mobile device location and the current time are used along with user profile information or user supplied search parameters to obtain relevant data from a content data store maintained in a mobile communications system.

FIG. 1 depicts a simplified schematic illustration of a mobile communications system 2 in which the various aspects of the invention may be carried out. The system 2 includes a communications network 4 with which a mobile communications device or unit 6 can communicate from a given current location L for sending and receiving calls and for transfer of data or other information to or from the device 6. Various data stores or databases are provided in the system 2, including standard static databases 20 and dynamic or customizable databases 30 which are operatively associated with the communications network 4 allowing network elements or other components of the communications system 2 to read and/or write data from or to the databases 20, 30.

In accordance with the invention, a dynamic content system is provided, including a profile database or other first data store 100 for storing profile entries for mobile communications devices 6, and a content database or other second data store 200 having content entries that individually comprise content, at least one geography relevance parameter, and at least one time relevance parameter. The content and profile data stores may be any suitable storage medium that is accessible by network elements or other components of the system 2, wherein one or both of the databases 100, 200 may be integrated with other system components, or can be unitary elements, or can be distributed across two or more system components, such as servers associated with a mobile communications network 4 or other networks (not shown) that are operatively coupled with the network 4, whereby data access is provided with the databases 100, 200 and the contents thereof. For instance, in one exemplary implementation of the invention described below, the content database 200 may be provided as a plurality of geographically relevant content databases that may be separately maintained at different locations within the communications system 2, where a central or global content data store may be updated by advertisers, news services, investment services, or other content providers, with content relevant to a particular region is replicated or otherwise provided from the central content database to one or several of the geographically relevant content databases. Likewise, the profile database 100 may be unitary or may be distributed across multiple network elements, for example, as profile data stores individually associated with home MSCs in a cellular communications network.

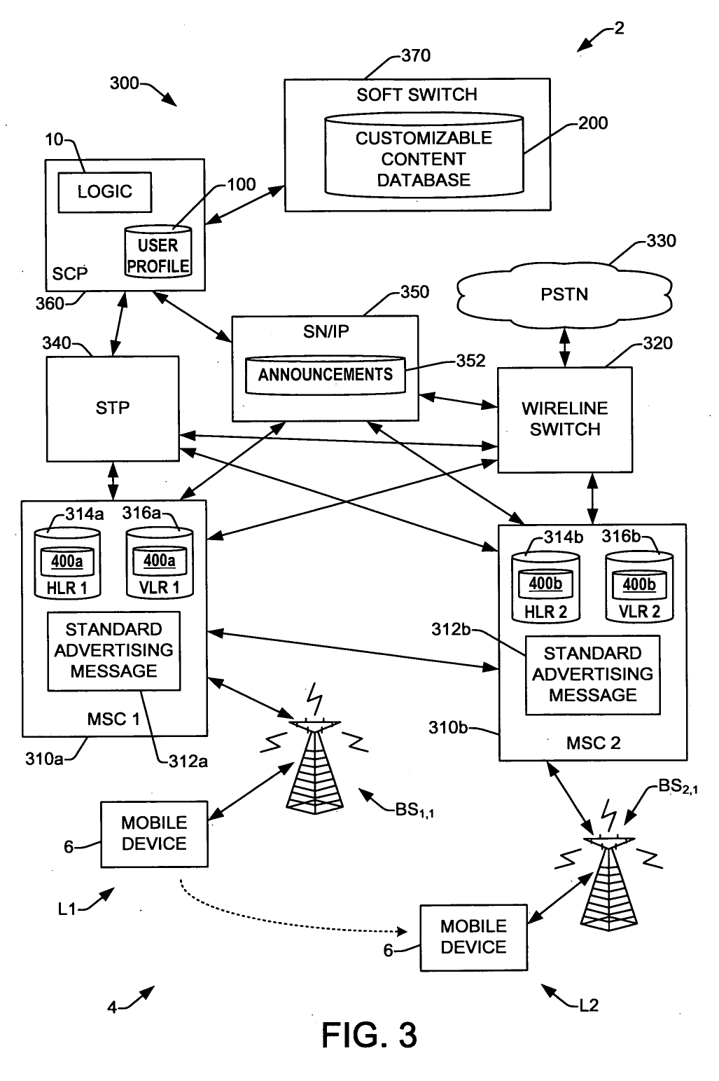

The dynamic content system also includes a logic component 10 that obtains a profile entry for a given mobile communications device 6 from the first data store, obtains profile specific geographically and temporally relevant content from the second data store according to the user profile, the current user location, and the current time, and provides the profile specific geographically and temporally relevant content to the given mobile communications device via a communications network. The logic 10 may be any single network element or may be implemented in distributed fashion across multiple network elements within the system 2 to carry out the functionality described herein. In one example shown in FIG. 3, below, the logic component 10 may be implemented in a service control point (SCP) of an intelligent network operatively coupled to the communications network 4.

Referring also to FIG. 2, an exemplary method 50 is illustrated for providing dynamic information to mobile communications devices, such as the exemplary mobile unit 6, based on current location L, the current time, and profile information for the device 6 from the profile database 100 in accordance with the invention. While the method 50 is illustrated and described hereinafter as a series of acts or events, it will be appreciated that methods of the invention are not limited by the illustrated ordering of such acts or events. In this regard, some acts or events may occur in different orders and/or concurrently with other acts or events apart from those illustrated and described herein, in accordance with the invention. It is further noted that not all illustrated steps may be required to implement a process in accordance with the present invention. The methods of the invention, moreover, may be implemented in association with the illustrated communications systems, messages, and user equipment, as well as with other apparatus not illustrated or described, wherein all such alternatives are contemplated as falling within the scope of the invention and the appended claims.

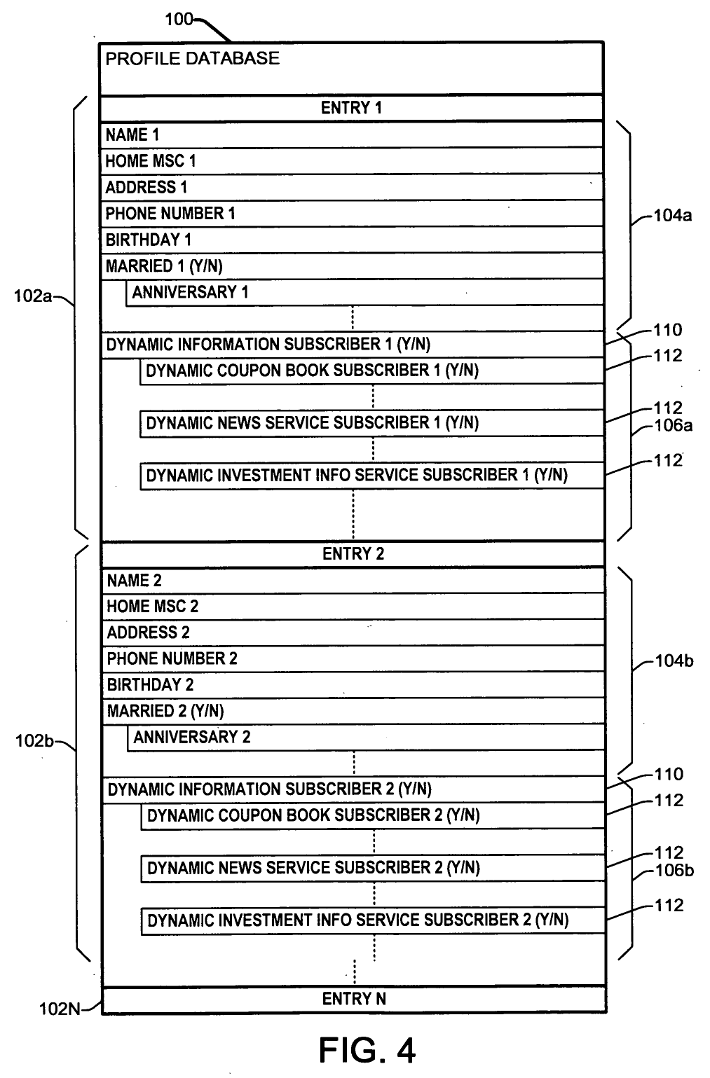

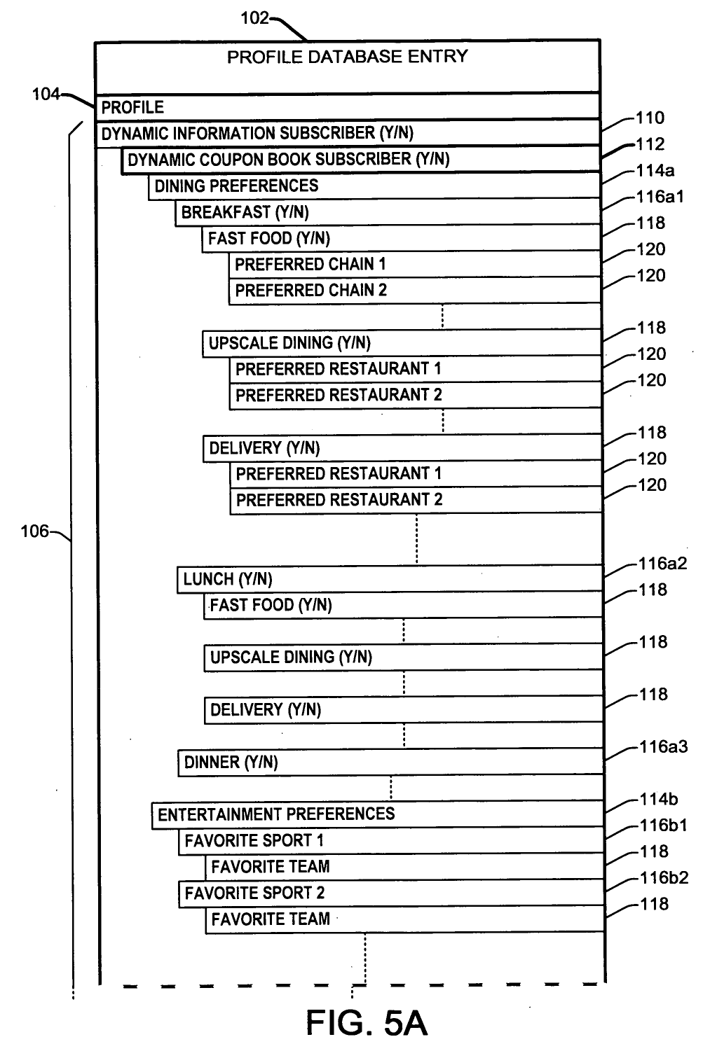

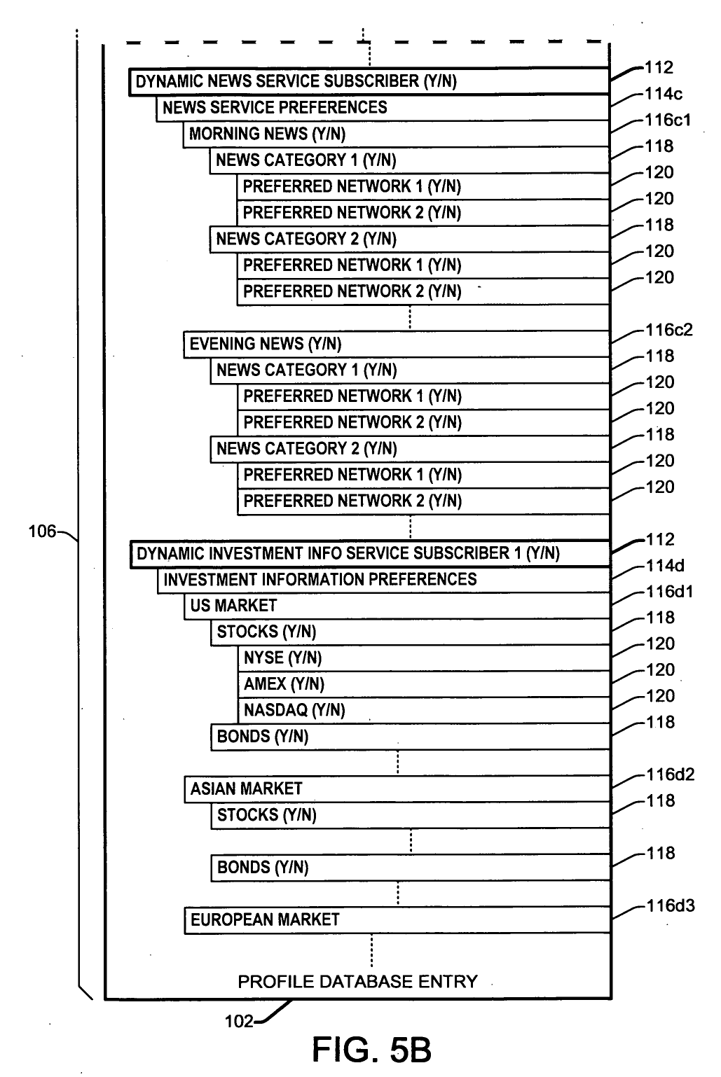

The method 50 of FIG. 2 may be implemented by the logic 10 in conjunction with the databases 100, 200 in the system 2 of FIGS. 1 and 3 for registering dual mode user equipment or in other systems not illustrated or described herein. At 52 in FIG. 2, the logic 10 obtains or ascertains the current location for the mobile device 6 in the system 2, by any suitable location technique, such as by determining an area in the mobile communications system 2 that is associated with an MSC currently serving the mobile communications device 6. The current time is ascertained by the logic 10 at 54 and the logic 10 obtains a profile at 56 (e.g., a profile database entry 102 having profile information 104 and subscription and other preference information 106 as shown in FIGS. 4-5B below) for the mobile device 6 from the profile database 100. At 58-70, the logic 10 selectively provides profile specific geographically and temporally relevant content to the mobile communications device 6 via the network 4 according, where the content is obtained by searching the content database 200 according to the user profile, the current user location, and the current time at 58. In the example of FIG. 2, moreover, the content may be provided together with one or more headers at 60, wherein general announcements and/or standard advertising headers are added to the profile specific geographically and temporally relevant content (search results from the database search at 58), and the content is pushed or otherwise provided to the user at 70 in a call. The call may be initiated by the customer, or may be an incoming call, where the dynamic content may be provided as a service on a subscription basis, with the user specifying what forms of content he or she wishes to receive, whether the calls will be initiated by the user or will be unprompted, and whether the user or an advertiser or other content provider will pay the charges for delivering the call.

Referring also to FIG. 3, a detailed illustration is provided of the system 2, in which the systems and methods of the invention may be implemented. The system 2 includes the dynamic content logic 10 and the profile and content databases 100 and 200, respectively, which are operatively coupled with a cellular wireless network 4 including various MSCs 310 and associated base stations BS providing wireless communications services to the mobile device 6. The device 6 is illustrated in two exemplary locations L1 and L2 within the system 2 in FIG. 3, where the first location L1 is serviced by a first MSC 310a and an associated base station BS_{1,1}, whereas the second location L2 is served by a second MSC 110b and base station BS_{2,1}. The first wireless MSC includes or is otherwise operatively coupled with a home location register (HLR 1) 314a and a visitor location register (VLR 1) 316a, and also provides a data store 312a including one or more standard advertising messages or headers for provision with the content to the mobile device 6 when positioned in the first location L1. When the mobile unit 6 moves to the second location L2, it is serviced by the corresponding second MSC 310b, which is associated with a second HLR 314b and VLR 316b, and similarly stores standard advertising header messages 312b. The wireless cellular network 4 is operatively connected to a wire-line network (PSTN) 330 via a wireline switch 320, and is further coupled with an intelligent network 300 including a signal transfer point (STP) 340, a service node/intelligent peripheral (SN/IP) 350 with an announcements database 352, a service control point (SCP) 360 that includes the logic 10 and the profile database 100, along with a soft switch 370 that maintains a central content database 200.

In one implementation of the dynamic content system and methods of the invention, the database 200 is accessed by the logic 10 to search for applicable content according to a profile entry from the profile database 100, and according to the current device location (e.g., L1 or L2), and the current time. In another implementation, geographically relevant content databases 400 are provided in different locations (e.g., in the HLRs 314 or VLRs 316, etc.) with entries that are relevant to the geographic locations served by the corresponding MSCs 310a and 310b, such that a search is performed in the database 400 corresponding to the current location of the device 6 at any given time. In this case, the central or global content database 200 may be maintained with all content entries, each having geography relevance indicators or parameters, with appropriate content entries being replicated or otherwise provided from the central content database 200 to one or more of the appropriate local content databases 400. In this manner, the content search is made of the corresponding local database 400 associated with the MSC 310a or 310b service the area in which the mobile unit 6 is currently located.

Referring also to FIGS. 4, 5A and 5B, further details of the exemplary profile database 100 are illustrated. As best seen in FIG. 4, the profile database 100 includes an integer number “N” entries 102 corresponding to N mobile devices 6 in the system 2, wherein several exemplary entries 102a, 102b, 102c, and 102N are illustrated in FIG. 4. Each entry 102 includes profile information 104, such as subscriber name, home MSC identifier, address, phone number, and time specific personal attributes such as birthday and wedding anniversary if married, etc. The entries 102 further include subscription and other preference information 106, such as an indication 110 as to whether the user subscribes to the dynamic information services of the invention, and if so, which types of content services (indicators 112) the user has selected. In the example of FIGS. 4-5B, the subscriber may choose any or all of dynamic coupon book type content services, dynamic news services, dynamic investment services, etc., as indicated by the fields 112 in the subscription and preferences portion 106 of the entry 102.

FIGS. 5A and 5B illustrate some examples of preference information 106 for the exemplary coupon book type content services, dynamic news services, dynamic investment services, etc., wherein each type includes one or more categories of preferences 114 (exemplary categories 114a-114d in FIGS. 5A and 5B) and subcategories 116, with preferences 118 and specific content providers being indicated at 120 for these subcategories in the preferences 106, wherein the illustrated database 100 and the entries 102 thereof are but one example of possible profile data store construction within the scope of the invention.

As illustrated in FIGS. 5A and 5B, the user may subscribe to dynamic coupon book content services, and may select to receive advertisement and/or coupon type content by calls to or from the mobile device 6, categorized in individually selectable categories and subcategories corresponding to dining (category 114a with temporally relevant subcategories 116a1, 116a2, and 116a3 for breakfast, lunch, and dinner, respectively), entertainment (category 114b with subcategories 116a and 116b specifying favorite sports with subcategories 118 for favorite teams as shown in FIG. 5A). The coupon book services allow the user to establish the profile information, for example, by an interactive series of menu screens on a PDA type device 6 or audible prompts, wherein certain of the preference information or selections 106 provide indications of temporal relevance. For instance, the dining preferences 114a are segmented into breakfast, lunch, and dinner categories 116a1-116a3, respectively, that are assigned different (possible overlapping) time relevance parameters, such as 6AM to noon for breakfast, 11AM to 4PM for lunch, 4PM to midnight for dinner, etc.

The logic 10 can thus use the preference information 106 from the profile database 100 to search and retrieve breakfast content (e.g., advertisements, coupons, specials, etc.) from 6AM to noon, breakfast and lunch content from 11AM to noon, lunchtime content only from noon to 4PM, etc. As shown in FIG. 5B, news services and investment services can likewise be specified for selective content provision to the user, wherein morning vs. evening news content can be filtered based on the current time, and likewise investment content can be temporally filtered using appropriate time relevance parameters according to when specific markets (US, Asian, European) are trading. Furthermore, the preferences 106 can be used to assign certain geographical boundaries or search ranges for content. For example, the selection of favorite sports teams in the entertainment preferences 114b (FIG. 5A) allows the logic 10 to selectively search for content within certain geography relevance parameters of the central content database 200.

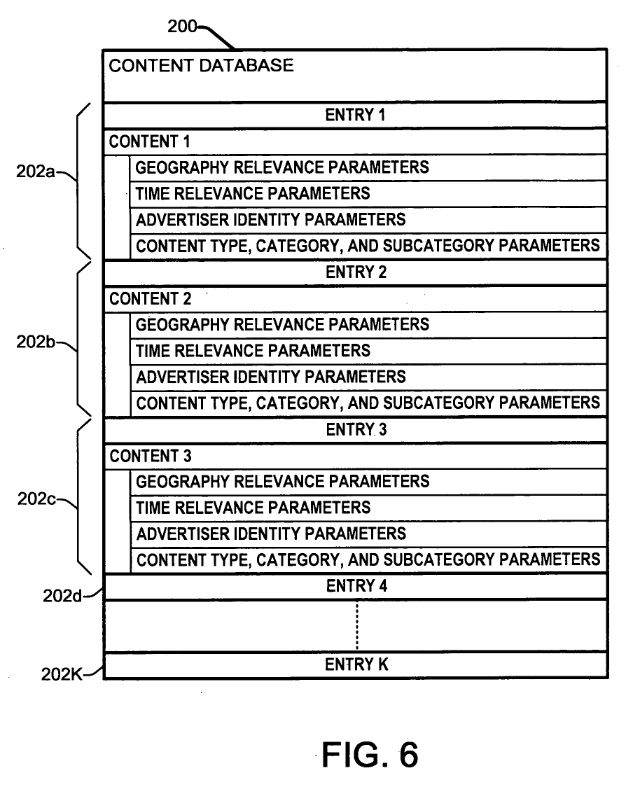

Referring also to FIG. 6, further details are illustrated for the exemplary content database 200 in the system 2, which includes an integer number “K” entries 202 having content, where some or all of the entries 202 include geography relevance parameters, time relevance parameters, and advertiser or content provider identity parameters, as well as parameters for content type, category, subcategory, etc. Several exemplary content entries 202a-202d and 202K are shown in FIG. 6, wherein the central database 200 is searchable by the logic element 10 according to various preferences 106 and profile information 104 (collectively the user profile), as well as according to the current time and current location for a given mobile device 6.

In operation, the logic 10 obtains the current location for a given mobile communications device 6, such as L1 or L2 in the mobile communications system 2, as shown in FIG. 3 (e.g., at 52 in the method 50 of FIG. 2), and retrieves the user profile entry 102 from the profile database 100 for the mobile communications device 6 (56 in FIG. 2), including the profile information 104 and the preferences 106. The logic 10 then searches the content database 200 according to the profile entry 102, the current time (e.g., current time obtained by any suitable means at 54 in FIG. 2, including optionally offsetting for time zone associated with the current location, depending on content type or other considerations), and retrieves the search results including profile specific, geographically and temporally relevant content, which is then provided to the user via the communications network 4.

It is noted that the content can be provided to a wireline device as well as to mobile devices 6, and that the content can be delivered in a call initiated by the logic 10 at certain times, or a call originated by the user. Thus, a user can place a coupon book access call when the user desires to know about dining or entertainment specials available at the current time and location, without having to construct an Internet search or consult newspapers or other media to ascertain the information. Elements of the user profile database entry 102, such as search filters, etc., can also be incorporated into the mobile device 6 (e.g., cell phone, PDA, etc.), wherein the logic component 10 can also obtain certain requested information and respond to user queries to gather relevant content to be provided to the user, wherein the user requests can be used to alter (e.g., narrow or broaden) the scope of the content searched, including changing time relevance filtering, geographic relevance filtering, and or subject matter filtering.

One example of the utility of the invention in the dynamic coupon service example would be where a user arrives in a new town (e.g., lands at an airport), wherein the service could be implemented by a coupon book call to provide the user with specials on dining, entertainment, lodging, etc. that are relevant to the user's current location at the current time. While traveling in a given city (e.g., in a cab from the airport to a hotel), the user could initiate a coupon book call have advertisements come up on a PDA or other mobile device 6 to alert the user to value propositions that are geographically convenient and that are a function of the time, day, date, and the user's preferences (profile). For instance, if the current time is 7:30AM, the logic 10 may operate using the profile entry 102 and the content database 200 to search for content related to breakfast dining, with the current location being used to help the user select from only nearby restaurants, with content only being provided for specific restaurants or type of food preferred or other preference parameters, wherein available specials are brought to the user's attention (e.g., preferred fast food restaurants having current breakfast specials nearby). Alternative scenarios include a different time of day (e.g., the system will also look for lunch options at 11:30AM), different user profile (e.g., “user prefers buffet” and the system will look for a different set of restaurants), and available advertisement (e.g., certain preferred content identities have available relevant content while others do not at a given time and location.

In another exemplary situation, the current time is determined to be the user's birthday (e.g., from the user profile), wherein the user can be offered a birthday special, such as food, entertainment, etc., depending on the content provided by advertisers in the content database 200. The temporal factors may also be dependent upon the day of the week, season, date, etc. For example, weekend specials at bed & breakfast establishments (e.g., based on the day of week), skiing trips in winter, seasonal/holiday specials (depending on the specific day of the year) are other variations of this scenario. For these scenarios, the appropriate time component will be used by the system.

Yet another example provides convergence of temporal and geographic relevance, wherein event tickets (e.g., for professional games, shows, etc.) may be made available by content providers at a discounted price because there are still seats available some time prior to the game or event. For a football game on a Sunday at noon, tickets might be discounted starting 4 hours before the game. In this case, the logic 10 will search the database 200 based on the time (e.g., 8 am and later), date (specific date of game), and user-profile (user loves sports, or is a football fan), as well as on proximity to the site of the game (e.g., in town or not, etc.). Another example is where credits and other incentives are selectively pushed to a user device 6 as an incentive to the user by a casino. In another possible variation, the user may initiate queries of the system for specific information, even if the request parameters are outside of (e.g., wider than) or a subset of (e.g., narrower than) the profile entry 102 in the database 100. The user may thus initiate the query, and the logic component 10 searches database 200, while selectively repressing temporal or geographic filtering to certain extents, to search and provide the information from the content database 200. As an example, a user who does not like football may be with a friend or a client who loves football. In this situation, the logic 10 receives one or more content search parameters from the mobile device 6 and selectively provides content according to the current user location and the search parameters, and according to at least one of the user profile and the current time. Thus, while the user-profile will normally cause football related information to not be delivered to the user, since the user is searching for information related to football, the information is provided by the system.

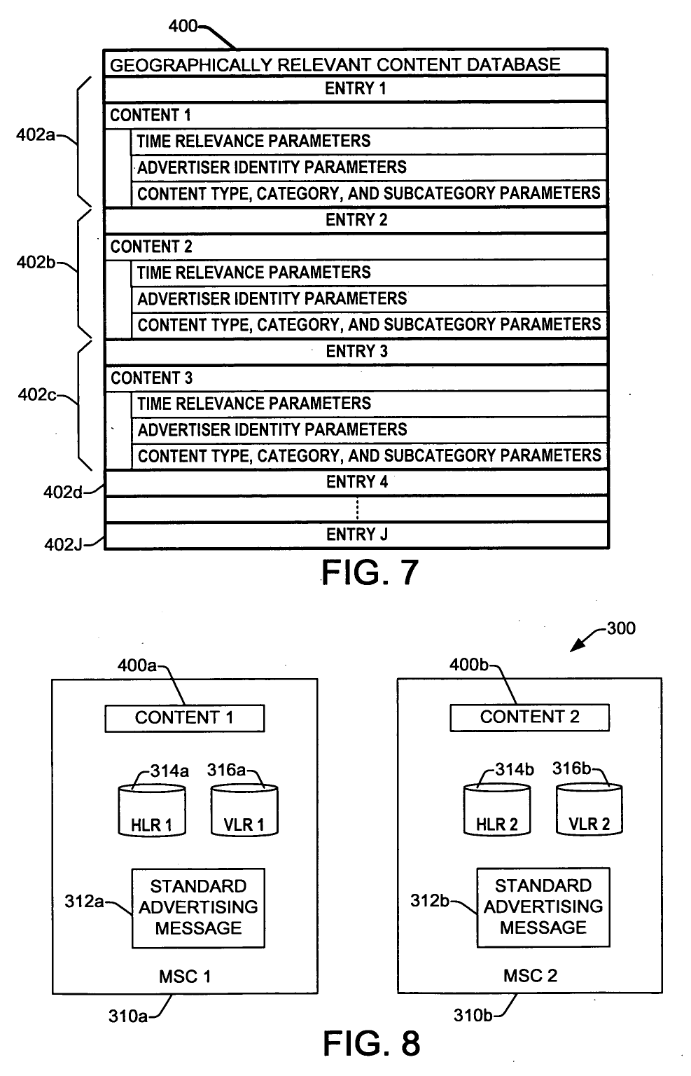

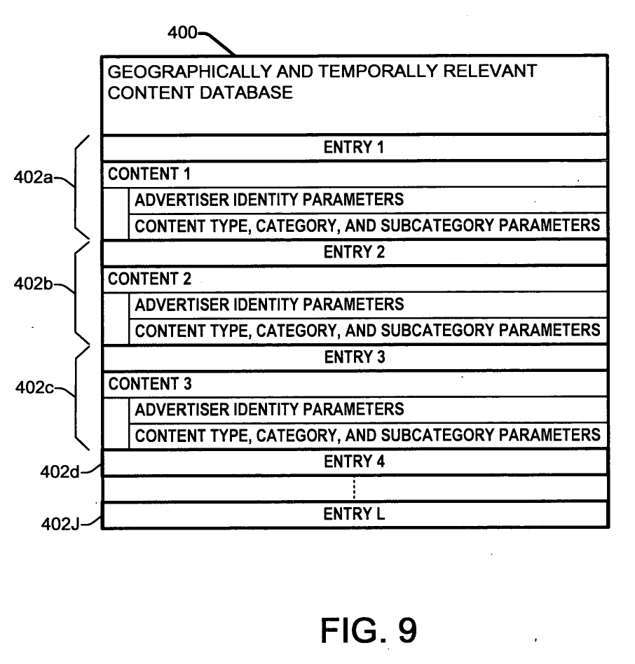

Referring now to FIGS. 3 and 7-9, the content data may be dispersed or distributed through replication or other suitable technique and stored in geographically relevant content databases 400, such as a content database 400a in the first MSC 310a and a second content database 400b in the second MSC 310b, as shown in FIG. 8. Alternatively, the geographically relevant databases 400 could be located within one or both of the associated HLR or VLR databases 314 or 316, respectively (FIG. 3). As best shown in FIG. 7, the geographically relevant content databases 400 individually corresponding to a given geographic area in the mobile communications system 2, and include content entries 402 from the central content database 200, wherein the entries 402 provided in a given geographically relevant database 400 have geography relevance parameters associated with the geographic area corresponding to the given geographically relevant database 400. In this manner, the content database need not be searched based on current location, but rather, the current device location is used to select which database is searched by the logic 10. In the example of FIG. 3, for instance, when the logic 10 determines that the device 6 is being serviced by the first MSC 310a (e.g., the device 6 is at location L1), the content database 400a is searched according to the user profile and the current time. When the device 6 moves to the second location L2, and is thus registered with the second MSC 310b, the logic 10 would search the corresponding database 400b by time and profile. Thus, the geographically relevant database 400 and the entries 402 thereof need not store geography relevance parameters. Another possibility is shown in FIG. 9, where the databases 400 are maintained such that only currently relevant content is stored therein, wherein these are referred to as geographically and temporally relevant databases 400. In this situation, the logic need only determine the user location and perform a search by profile information of the relevant database 400, which need not store geography or temporal relevance parameters.

Although the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A method in a mobile communications system for providing dynamic information to mobile communications devices based on current location, current time, and profile information, the method comprising:
obtaining a current location for a mobile communications device in the mobile communications system;
obtaining a profile for the mobile communications device from a profile database in the mobile communications system; and
selectively providing profile specific geographically and temporally relevant content to the mobile communications device via a communications network according to the user profile, the current user location, and the current time.

2. The method of claim 1, wherein providing the profile specific geographically and temporally relevant content comprises searching a content database according to the user profile, the current user location, and the current time.

3. The method of claim 1, wherein providing the profile specific geographically and temporally relevant content comprises searching a geographically relevant content database according to the user profile and the current time.

4. The method of claim 3, wherein providing the profile specific geographically and temporally relevant content comprises searching a first one of a plurality of geographically relevant content databases that is associated with an MSC serving the mobile communications device at the current location according to the user profile and the current time.

5. The method of claim 3, further comprising:
providing a content database in the mobile communications system, the content database including a plurality of content entries, the content entries including geography relevance parameters;
providing a plurality of geographically relevant content databases individually corresponding to a given geographic area in the mobile communications system; and
selectively providing content entries from the content database to the geographically relevant content databases, wherein the content entries provided to a given geographically relevant database have geography relevance parameters associated with the geographic area corresponding to the given geographically relevant database;
wherein providing the profile specific geographically and temporally relevant content comprises searching a first one of the plurality of geographically relevant content databases corresponding to the current location for the mobile communications device according to the user profile and the current time.

6. The method of claim 1, wherein providing the profile specific geographically and temporally relevant content comprises searching a geographically and temporally relevant content database according to the user profile.

7. The method of claim 6, wherein providing the profile specific geographically and temporally relevant content comprises searching a first one of a plurality of geographically and temporally relevant content databases that is associated with an MSC serving the mobile communications device at the current location according to the user profile.

8. The method of claim 6, further comprising:
providing a content database in the mobile communications system, the content database including a plurality of content entries, the content entries including geography relevance parameters and time relevance parameters;
providing a plurality of geographically and temporally relevant content databases individually corresponding to a given geographic area in the mobile communications system;
selectively providing content entries from the content database to the geographically and temporally relevant content databases, wherein the content entries provided to a given geographically and temporally relevant database have geography relevance parameters associated with the geographic area corresponding to the given geographically relevant database and time relevance parameters corresponding to the current time; and
selectively removing content entries from a given geographically and temporally relevant database when the time relevance parameters no longer correspond to the current time;
wherein providing the profile specific geographically and temporally relevant content comprises searching a first one of the plurality of geographically and temporally relevant content databases corresponding to the current location for the mobile communications device according to the user profile.

9. The method of claim 1, wherein obtaining the current location for the mobile communications device comprises determining an area in the mobile communications system that is served by an MSC currently serving the mobile communications device.

10. The method of claim 1, wherein the profile is obtained from an HLR or VLR database associated with a serving or home MSC in the mobile communications system.

11. The method of claim 1, wherein the profile is obtained from a profile database associated with a service control point (SCP) in the mobile communications system.

12. The method of claim 1, further comprising receiving one or more content search parameters from the mobile communications device; and selectively providing content to the mobile communications device via a communications network according to the current user location and the search parameters, and according to at least one of the user profile and the current time.

13. A dynamic content system for providing dynamic information to mobile communications devices in a mobile communications system, the dynamic content system comprising:
a profile database in the mobile communications system;
means for obtaining a profile for a mobile communications device from the profile database;
means for obtaining a current location for the mobile communications device in the mobile communications system; and
means for selectively providing profile specific geographically and temporally relevant content to the mobile communications device via a communications network according to the user profile, the current user location, and the current time.

14. The dynamic content system of claim 13, wherein the profile database is operatively associated with a service control point (SCP) in the mobile communications system.

15. The dynamic content system of claim 13, wherein the means for selectively providing profile specific geographically and temporally relevant content to the mobile communications device comprises:
a content database in the mobile communications system, the content database including a plurality of content entries, the content entries including geography relevance parameters and time relevance parameters; and
a logic element operative to search the content database according to the user profile, the current user location, and the current time and to provide the profile specific geographically and temporally relevant content to the mobile communications device.

16. The dynamic content system of claim 13, wherein the means for selectively providing profile specific geographically and temporally relevant content to the mobile communications device comprises:
a plurality of geographically relevant content databases individually corresponding to a given geographic area in the mobile communications system; and
a logic element operative to search a first geographically relevant content database that corresponds to an area including the current location of the mobile communications device according to the user profile and according to the current time and to provide the profile specific geographically and temporally relevant content to the mobile communications device.

17. The dynamic content system of claim 13, wherein the means for selectively providing profile specific geographically and temporally relevant content to the mobile communications device comprises:
a plurality of geographically and temporally relevant content databases individually corresponding to a given geographic area in the mobile communications system; and
a logic element operative to search a first geographically and temporally relevant content database that is associated with the current location of the mobile communications device according to the user profile.

18. The dynamic content system of claim 13, wherein the profile database is in an HLR or VLR database associated with a serving or home MSC in the mobile communications system.

19. The dynamic content system of claim 13, wherein the profile database is associated with a service control point (SCP) in the mobile communications system.

20. A dynamic content system for providing geographically and temporally relevant content to mobile communications devices, comprising:
a first data store including profile entries corresponding to individual mobile communications devices in a mobile communications system;
a second data store including a plurality of content entries that individually comprise content, at least one geography relevance parameter, and at least one time relevance parameter; and
a logic component that obtains a profile entry for a given mobile communications device from the first data store, obtains profile specific geographically and temporally relevant content from the second data store according to the user profile, the current user location, and the current time, and provides the profile specific geographically and temporally relevant content to the given mobile communications device via a communications network.

21. The dynamic content system of claim 20, wherein the second data store comprises a plurality of geographically relevant content databases individually corresponding to a given geographic area in the mobile communications system, and wherein the logic component searches a first one of the geographically relevant content databases that corresponds to an area including the current location of the mobile communications device according to the user profile and according to the current time and provides the profile specific geographically and temporally relevant content to the mobile communications device.
